(19) United States
(12) Patent Application Publication
(10) Pub. No.: US 2024/0301106 A1
(43) Pub. Date: Sep. 12, 2024

(54) Catalytic, Sulfur-Free Chain Transfer Agent for Modulation of Network Topology in Crosslinked Photopolymers

(71) Applicant: University of Denver, Denver, CO (US)

(72) Inventors: Brady Worrell, Denver, CO (US); Brian Donovan, Denver, CO (US); Nicholas Bagnall, Littleton, CO (US); Meredith Jones, Denver, CO (US)

(73) Assignee: University of Denver, Denver, CO (US)

(21) Appl. No.: 18/587,704

(22) Filed: Feb. 26, 2024

Related U.S. Application Data
(63) Continuation-in-part of application No. PCT/US23/36516, filed on Oct. 31, 2023.
(60) Provisional application No. 63/421,040, filed on Oct. 31, 2022.

(51) Int. Cl. C08F 220/14

(52) U.S. Cl. CPC C08F 220/14

(57) ABSTRACT

A method for tailoring mechanical properties of a photopolymer includes providing an active monomer feedstock, adding a sulfur-free chain transfer agent (CTA) to the active monomer feedstock to form a mixture, and curing the mixture under predetermined conditions. The sulfur-free CTA includes a Cobalt(II) complex or a Cobalt(III) complex, the mechanical properties include glass transition temperature, crosslinking density, and/or conversion rate, and a concentration of the sulfur-free CTA is less than 30% of the mixture. The predetermined conditions include intensity, wavelength, and application time of energy from a light source, a cure temperature, and/or the concentration of the sulfur-free CTA in the mixture. The method may further include adding a diluent to the mixture to modify a viscosity of the active monomer feedstock. The diluent may include one of a reactive diluent and a non-reactive diluent, such as methyl methacrylate (MMA) and methacrylate (MA).

### REFERENCE TO RELATED APPLICATIONS

The present application claims the benefit of U.S. Prov. Pat. App. No. 63/421,040, filed 2022 Oct. 31 and titled “Catalytic Modulation of Network Topology in Crosslinked Photopolymers.” The present application is a Continuation-In-Part of PCT International Pat. App. No. PCT/US23/36516, filed 2023 Oct. 31 and titled “Catalytic Modulation of Network Topology in Crosslinked Photopolymers.” Both of the above-referenced applications are incorporated hereby in their entirety by reference.

### SPONSORED RESEARCH AND DEVELOPMENT

This invention was made with government support under CHE-2240141 awarded by the National Science Foundation. The government has certain rights in the invention.

### FIELD OF THE INVENTION

The present invention relates to catalysts and methods used to form photopolymers using catalytic chain transfer mechanisms.

### DESCRIPTION OF RELATED ART

Photopolymerization is a technique where light acts as a contactless stimulus, creating free radicals in great abundance. These free radicals convert mixtures of multifunctional methacrylate monomers into crosslinked thermosetting polymers. These photopolymers are highly crosslinked and tend to be brittle, exhibit high shrinkage, and have a limited range of material properties. CTAs have been employed to attempt to modulate the DP of the kinetic chain and improve the material properties. Non-catalytic sulfur-based CTAs have been successfully employed to modulate the crosslinking density (XLD) of these photopolymers. Examples of sulfur-based CTAs include mono- and multi-functional thiols, trithiocarbonates, dithiocarbonates, allyl sulfides, beta-allyl sulfones, vinyl sulfonate esters among others. The sulfur-based CTAs are required to be used in high loading (10 wt %-30 wt %), are malodorous, impart unwanted color to the polymer, and often create unstable formulations.

Accordingly, it would be advantageous to develop CTAs that can be used in the formation of photopolymers that allow broad control of the crosslinking and material properties of the photopolymer, can be used in small amounts, are not malodorous, do not impart unwanted color to the polymer, and create stable formulations.

Further, determining the optimal formulation to produce a desired crosslinked photopolymer is a painstaking and slow process that requires large quantities of materials, multiple pieces of analysis equipment, and large amounts of manpower. There are many variables that must be evaluated. Examples include light wavelength, intensity and duration (dose), photoinitiator identity and concentration, monomer(s) identity and concentration, temperature, CTA identity and concentration, presence of additives identity and concentration, among others. For each trial in the screening plan, enough polymer must be produced to allow the analysis of a suite of material properties. Examples of relevant material properties include crosslink density, toughness, solvent resistance, glass transition temperature, storage modulus (G′) loss modulus (G″), normal force (FN), shrinkage stress, among others. Several of these properties need to be determined as a function of temperature.

Accordingly, it would be advantageous to develop systems and methods that would allow high throughput screening of interesting polymers and reduce the time, amount of material, and manpower to investigate a wide range of the polymerization parameter space.

### SUMMARY OF THE INVENTION

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its purpose is to present some concepts of one or more aspects in a simplified form as a prelude to the more detailed description.

In embodiments, a method for producing photopolymers includes providing an active monomer feedstock, adding a catalytic chain transfer agent (CTA) to form a mixture with less than 30% concentration of the catalytic CTA, and applying energy from a light source to form a photopolymer structure, wherein the catalytic CTA is a Cobalt(II)-based catalyst. In certain embodiments, the concentration of the catalytic CTA is on the order of ten parts per million (ppm) of the mixture or less. In embodiments, the concentration of the catalytic CTA is on the order of ten parts per billion (ppb) of the mixture.

In embodiments, the catalytic CTA is sulfur-free, and the catalytic CTA exhibits a chain transfer constant 10 times higher or more than that of a sulfur-based catalytic CTA.

In embodiments, the method includes adding a sigma-donating ligand (e.g., nitrogen-containing heterocycles, oxygen-containing heterocycles, sulfur-containing heterocycles, organophosphorus containing molecules, halide salts, nitrogen containing molecules, or oxygen containing molecules) to the catalytic CTA such that material properties (e.g., mechanical properties, optical properties, crosslinking density, and shelf stability) of the photopolymer structure therewith are modified.

In embodiments, the active monomer feedstock includes a methacrylate monomer, a petroleum-derived (meth)acrylate, and/or a poly(methyl methacrylate) (PMMA). In embodiments, a molecular weight of the PMMA in the photopolymer structure is reduced from an order of thousands of Dalton (Da) in an unmodified photopolymer structure without the catalytic CTA to an order of hundreds of Da in the photopolymer including the catalytic CTA.

In embodiments, the catalytic CTA includes a Co(II)-complex. In embodiments, the catalytic CTA includes a Co(III)-hydride (Co(III)-H).

In embodiments, two or more wavelengths of light may be applied to the mixture to form the photopolymer.

In some embodiments, Co-based complexes are applied to the formation of photopolymers. The Co-based complexes are catalytic and can be used in small quantities (ppb to ppm levels) to modulate the network topology of the growing photopolymer. The molecular structure and concentration of the Co-based complexes can be varied to affect the material properties of the resulting photopolymer such as molecular weight, crosslink density, toughness, solvent resistance, thermal stability, glass transition temperature, storage modulus (G′) loss modulus (G″), normal force (FN), shrinkage stress among others. In some embodiments, the catalytically active species may be generated in-situ to provide temporal and spatial control of the photopolymer properties or to modulate gelation kinetics.

In embodiments, methods of using Co(II)-based catalysts in the synthesis of photopolymers are provided. The material properties of the resulting photopolymer may be changed by altering the R groups attached to the Co-based catalyst, the ligands attached to the Co-based catalyst, the concentration of the Co-based catalyst during the photopolymerization, and the oxidation state of the Co-based catalyst (e.g., reduction of Co(III) to Co(II) in situ). Methods for the high throughput screening, synthesis, and analysis of photopolymers formed using Co-based catalysts are provided.

Additionally, systems and methods are provided that allow for the improved high throughput screening of interesting polymers. The systems and methods allow for a reduction in the time, amount of material, and manpower required to investigate a wide range of the polymerization parameter space.

In a further embodiment, a method for tailoring mechanical properties of a photopolymer includes providing an active monomer feedstock, adding a sulfur-free chain transfer agent (CTA) to the active monomer feedstock to form a mixture, and curing the mixture under predetermined conditions. The sulfur-free CTA includes at least one of a Cobalt(II) complex and a Cobalt(III) complex, the mechanical properties include at least one of glass transition temperature, crosslinking density, and conversion rate, and a concentration of the sulfur-free CTA is less than 30% of the mixture.

In embodiments, the predetermined conditions include intensity, wavelength, and application time of energy from a light source, a cure temperature, and the concentration of the sulfur-free CTA in the mixture.

In a further embodiment, the method further includes adding a diluent to the mixture to modify a viscosity of the active monomer feedstock. In certain embodiments, the diluent includes at least one of a reactive diluent and a non-reactive diluent. In embodiments, the diluent includes at least one of methyl methacrylate (MMA) and methacrylate (MA).

In certain embodiments, adding the sulfur-free CTA includes adding CoBF-iPr as the sulfur-free CTA.

These and other features, and characteristics of the present technology, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of ‘a’, ‘an’, and ‘the’ include plural referents unless the context clearly dictates otherwise.

### BRIEF DESCRIPTION OF DRAWINGS

The appended drawings illustrate only some implementations and are therefore not to be considered limiting of scope.

FIGS. 1A and 1B illustrate examples of the formation of polymers under different processing conditions, in certain embodiments.

FIG. 2 illustrates the synthesis of the family of Co-based catalysts, in certain embodiments.

FIGS. 3A and 3B illustrate examples of the formation and analysis of polymers under different processing conditions, in certain embodiments.

FIG. 4 presents analytical data of representative photopolymers.

FIG. 5 presents analytical data of representative photopolymers.

FIG. 6 presents analytical data of representative photopolymers.

FIG. 7 presents analytical data of representative photopolymers.

FIG. 8 presents alternative R groups and ligands used in the Co-based catalysts, in certain embodiments.

FIGS. 9A and 9B illustrate a scheme for the high throughput synthesis and analysis of photopolymers formed using Co-based catalysts, in certain embodiments.

FIGS. 10A and 10B illustrate a process whereby inactive Co(III) complexes can be activated using light to generate active Co(II)-based catalysts in-situ, in certain embodiments.

FIGS. 11A and 11B illustrate examples of Co(II) and Co(III) complexes suitable for use in certain embodiments. Particularly, FIG. 11A shows an exemplary formulation of a Co(II) complex CoBF, in accordance with embodiments. FIG. 11B shows an exemplary formulation of a Co(III) complex CoBF-iPr, in accordance with embodiments.

FIG. 12 illustrates examples of a Co(III) complex and variations suitable for use in certain embodiments.

FIG. 13A shows experimental results illustrating the effect of different loads of an exemplary Co(II) complex on the glass transition temperature for a rubbery photopolymer system.

FIGS. 13B-13F illustrates a workflow of photopolymerization of methacrylated sebacic acid (MSA) into a thin film, and subsequent analysis thereof. In particular, FIG. 13B illustrates photopolymerization of methacrylated sebacic acid (MSA) into a thin film with overlayed nuclear magnetic resonance (NMR) spectroscopy results obtained from characterization of t-PMAA. FIG. 13C shows representative Fourier Transform Infrared (FTIR) spectroscopy and size-exclusion chromatography (SEC) data showing the effect of CoBF loading on the polymerization. FIG. 13D shows FTIR kinetic plots of the photopolymerization of MSA in the presence of varying loadings of CoBF. FIG. 13E shows SEC plots showing reduced molecular weight with increased loadings of CoBF. FIG. 13F shows a Mayo plot of the SEC data of FIG. 13F.

FIGS. 14A-C show experimental results illustrating the effect of different concentrations of an exemplary Co(III) complex on the conversion percentage for a glassy photopolymer system. Particularly, FIG. 14A shows the conversion percentage as a function of time when the system is cured at 25° C. (room temperature (RT)). FIG. 14B shows the conversion percentage as a function of time when the system is cured at 50° C. FIG. 14C shows the conversion percentage as a function of time when the system is cured at 100° C.

FIGS. 15A-C show experimental results illustrating the effect of different loads of an exemplary Co(III) complex on the glass transition temperature for a glassy photopolymer system. Particularly, FIG. 15A shows the measured tan δ as a function of temperature when the system is cured at 25° C. (RT). FIG. 15B shows the measured tan δ as a function of temperature when the system is cured at 50° C. FIG. 15C shows the measured tan δ as a function of temperature when the system is cured at 100° C.

FIGS. 16A-C show experimental results illustrating the effect of reactive diluent concentration on the conversion percentage for a glassy photopolymer system including 30 wt % of triethylene glycol dimethacrylate (TEDGMA) with varying ratios of urethane dimethacrylate (UDMA) and diethylene glycol dimethacrylate (DEGDMA). In this case, the DEGDMA serves as a reactive diluent in the formulation. Particularly, FIG. 16A shows the conversion percentage for different concentrations of CoBF-iPr as a function of time when the system includes 65 wt % of UDMA, 5 wt % of DEGDMA, and 30 wt % of TEDGMA. FIG. 16B shows the conversion percentage as a function of time when the system includes 55 wt % of UDMA, 15 wt % of DEGDMA, and 30 wt % of TEDGMA. FIG. 16C shows the conversion percentage as a function of time when the system includes 45 wt % of UDMA, 25 wt % of DEGDMA, and 30 wt % of TEDGMA.

FIGS. 17A-C show experimental results illustrating the effect of non-reactive diluent concentration on the conversion percentage for a glassy photopolymer system including 30 wt % of TEDGMA with varying ratios of UDMA and diethylene glycol dimethyl ether (DEGDME). Particularly, FIG. 17A shows the conversion percentage for different concentrations of CoBF-iPr as a function of time when the system includes 65 wt % of UDMA, 5 wt % of DEGDME, and 30 wt % of TEDGMA. FIG. 17B shows the conversion percentage as a function of time when the system includes 55 wt % of UDMA, 15 wt % of DEGDME, and 30 wt % of TEDGMA. FIG. 17C shows the conversion percentage as a function of time when the system includes 45 wt % of UDMA, 25 wt % of DEGDME, and 30 wt % of TEDGMA.

FIG. 18A shows experimental results illustrating the effect of light intensity and different loads of an exemplary Co(III) complex on the conversion percentage for a rubbery photopolymer system.

FIG. 18B illustrates an exemplary mechanism for the photopolymerization process that is affected by the modification of the light intensity used during the cure.

FIGS. 19A-C show experimental results illustrating the effect of light intensity and different loads of an exemplary Co(III) complex on the conversion percentage for a glassy photopolymer system. Particularly, FIG. 19A shows the conversion percentage as a function of time when the system is cured at 25° C. (RT) under different light intensity conditions and loads of CoBF-iPr. FIG. 19B shows the conversion percentage as a function of time when the system is cured at 50° C. under different light intensity conditions and loads of CoBF-iPr. FIG. 19C shows the conversion percentage as a function of time when the system is cured at 100° C. under different light intensity conditions and loads of CoBF-iPr.

FIGS. 20A-B show experimental results illustrating the difference in the material property provided by including a methacrylate (MA) or a methyl methacrylate (MMA) for a rubbery photopolymer system. Particularly, FIG. 20A shows the conversion percentage as a function of time when the system includes 50 ppm of CoBF-iPr and different ratios by weight of MMA. FIG. 20B shows the conversion percentage as a function of time when the system includes 50 ppm of CoBF-iPr and different ratios by weight of MA.

FIG. 21 shows experimental results illustrating the effect of light intensity and different loads of an exemplary Co(III) complex on the conversion percentage for a rubbery photopolymer system including a methacrylate.

For simplicity and clarity of illustration, the drawing figures illustrate the general manner of construction, and descriptions and details of well-known features and techniques may be omitted to avoid unnecessarily obscuring the embodiments detailed herein. Additionally, elements in the drawing figures are not necessarily drawn to scale. For example, the dimensions of some of the elements in the figures may be exaggerated relative to other elements to help improve understanding of the described embodiments. The same reference numerals in different figures denote the same elements.

The word “exemplary” is used herein to mean “serving as an example, instance, or illustration.” Any embodiment described herein as “exemplary” is not necessarily to be construed as preferred or advantageous over other embodiments. In the following detailed description, references are made to the accompanying drawings that form a part hereof, and in which are shown by way of illustrations or specific examples. These aspects may be combined, other aspects may be utilized, and structural changes may be made without departing from the present disclosure. Example aspects may be practiced as methods, systems, or apparatuses. The following detailed description is therefore not to be taken in a limiting sense, and the scope of the present disclosure is defined by the appended claims and their equivalents.

### DETAILED DESCRIPTION OF THE INVENTION

Herein described are embodiments of a catalytic, sulfur-free chain transfer agent (CTA) that can be added in parts per million (ppm) quantities to monomer feedstocks to create crosslinked photopolymers like those prepared using traditional, sulfur-based chain transfer agents, but at 1,000 to 10,000 times lower CTA loadings. This catalyst may be incorporated into industrially relevant formulations and cured using standard practices with no special precautions or instrumentation. The resultant materials were found to have narrowed and reduced the glass transition temperatures, lower rubbery moduli, and other desirable mechanical properties. Described herein is a new class of CTA based on a transition metal, and the addition of small quantities of exogenous ligands were found to drastically alter catalyst performance, which may lead to further improvements in catalyst efficiency. This technology has potential applications in 3D printing, dentistry, protective coatings, adhesives, and liquid crystals.

The catalyst CTAs described herein may supplant sulfur-based chain transfer agents currently utilized in the formulation and processing of industrially relevant photopolymers. As discussed above, sulfur-based CTAs are required to be utilized in high loadings (up to 30 wt % of the total formulation) and, although they effectively reduce crosslinking density, because they account for a significant portion of the formulation can also negatively impact mechanical or material performance. For example, in crosslinked liquid crystals, large quantities of sulfur-based CTAs can dilute mesogen concentration, disrupt alignment, and create materials with paltry optical and mechanical properties. Further, sulfur-based CTAs generally impart color in the produced component, are inherently malodorous, and do not form shelf-stable formulations. Instead, only very small quantities (parts per billion (ppb) to ppm) quantities of the catalyst CTAs described herein is needed to be added to standard photopolymer formulations to obtain similar crosslinking densities and desired properties as sulfur-based CTAs while having no detectable smell and improving the stability and storability of the resulting photopolymeric resins. As a result, the catalyst CTAs described herein enable the formation of stronger, tougher, and more uniform materials, thus providing greater flexibility and scope of possible formulations of photopolymeric materials.

Cobalt(II)-porphyrin complexes have been used as chain transfer agents (CTA) to form low molecular weight terminated-PMMA (t-PMMA) through thermally initiated free radical polymerization of MMA. The t-PMMA polymers formed using the cobalt (Co)-based CTAs are short linear polymers terminated with alkene groups with low molecular weights (hundreds of Daltons (Da) instead of thousands of Daltons). The mechanism for forming these polymers is known as catalytic chain transfer (CCT) polymerization.

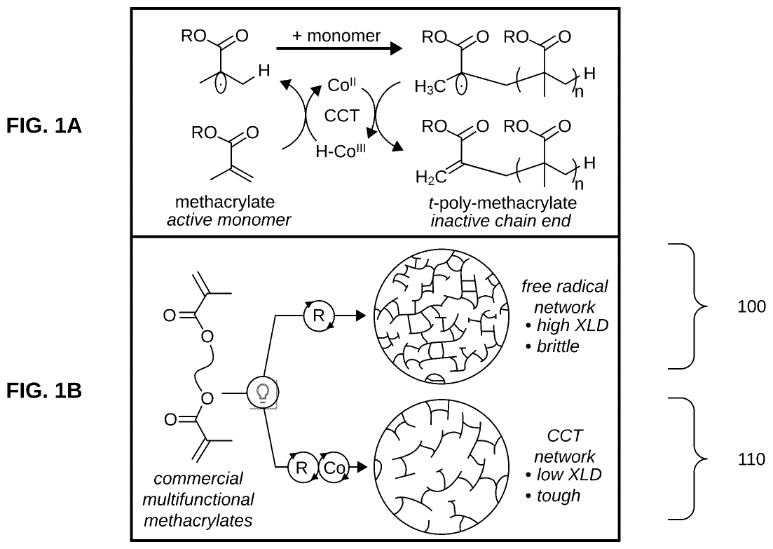

FIG. 1A illustrates a commonly accepted thermally activated CCT mechanism for the use of Co-based CTAs to form t-PMMA polymers. This method results in lower molecular weight linear t-PMMA polymers with alkene terminated ends.

FIG. 1B illustrates two pathways for the formation of photopolymers. The upper pathway, 100, involves the use of light to activate a photoinitiator to generate free radicals. The free radicals generate a polymer that has a high crosslinking density and brittle material properties.

The bottom pathway, 110, involves the use of light to activate a photoinitiator to generate free radicals in the presence of a Co-based catalyst. The Co-based catalyst can be used in small quantities (ppb to ppm levels) to modulate the network topology of the growing photopolymer. The Co-based catalyst is acting as a chain transfer agent (CTA) as discussed earlier. The resulting polymer has a lower crosslink density and has improved material properties such as toughness, etc.

Herein described are Co-based catalyst CTAs suitable for use with photopolymeric resins. These photopolymers have applications in the fields of additive manufacturing (3D printing), dentistry, adhesives, photonics, liquid crystal displays and actuators, protective coatings, among others. Direct evidence of catalytic chain transfer using a macrocyclic cobalt(II) complex has been obtained under relevant photopolymerization conditions, as described in detail below. Cobalt(II)-based catalysts were found to have chain transfer constants up to 1,000 times higher than the highest performing known CTA. Mechanical characterization of various commercially relevant formulations (such as those used in 3D printing resins and dentistry) were photopolymerized in the presence of this catalyst and were found to have correspondingly lower glass transition temperatures (e.g., 100 ppm of the macrocyclic cobalt catalyst reduced glass transition temperature T_{g} by ^{˜}20° C.) and rubbery moduli (E′). These mechanical characteristics (T_{g} and E′) were found to be tunable by changing the concentration of the catalytic CTA in the resin.

The CTAs described here are catalytic and are not consumed like traditional CTAs during photopolymerization. Additionally, a large library of sigma-donating ligands can be evaluated which can increase or tune catalyst efficiency for a given photopolymer formulation. Some ligands that may be useful for certain application are nitrogen, oxygen or sulfur containing heterocycles (e.g., substituted pyridines), organophosphorus containing molecules (e.g., triarylphosphines), halides (e.g., tetrabutylammonium halide salts), nitrogen containing molecules (e.g., trialkylamines), oxygen containing molecules (e.g., ketones), and similar. In embodiments, size exclusion chromatography analysis of linear polymers formed by the addition of ppm quantities of a macrocyclic cobalt(II) complex to a digestible dimethacrylate confirm that cobalt(II) complexes may act as potent, catalytic chain transfer agents in photopolymeric materials.

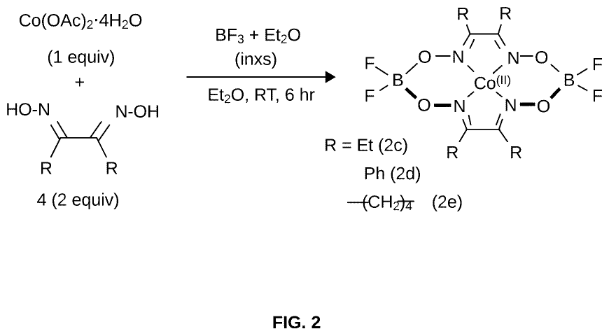

FIG. 2 illustrates the synthesis of families of Co-based catalysts. A wide variety of Co-based catalysts may be screened. For example, the Co-based catalyst shown in FIG. 2 where R is a methyl group may exhibit poor solubility in methacrylate monomer resins, while having a high activity. As illustrated in FIG. 2, cobalt(II) acetate tetrahydrate is reacted with two equivalents of a glyoxime in the presence of an excess of boron trifluoride diethyl etherate at room temperature. Conveniently, the catalysts prepared from this method precipitate and can be isolated by filtration. Large families of Co-based catalysts can be synthesized by altering the R group on the glyoxime as indicated in FIG. 2. This process forms a large family of compounds known as cobaloximes.

While FIG. 2 lists three potential R groups, this number is not meant to be limiting and it may be noted a broad range of potential R groups that may be evaluated. Properties such as solubility, stability, and catalytic activity of each Co-based catalyst may then be evaluated in the formation of photopolymers. In some embodiments, the R groups on the glyoxime are the same as those resulting in Co-based catalysts wherein all four R groups are the identical. In some embodiments, the R groups on the glyoxime may be different from each other, thus resulting in Co-based catalysts wherein all four R groups are not the same.

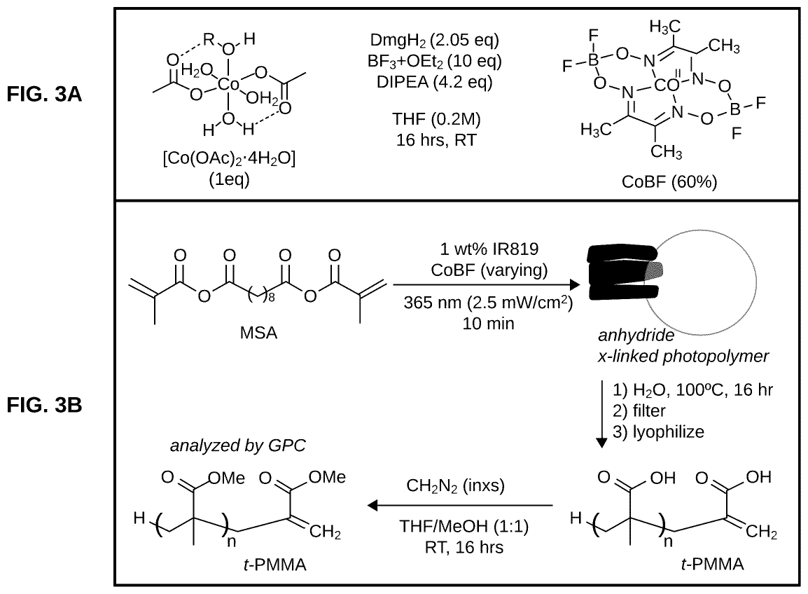

FIG. 3A illustrates exemplary Co-based catalyst synthesis for a specific compound. As discussed with respect to FIG. 2, cobalt(II) acetate tetrahydrate is reacted with dimethylglyoxime (DmgH₂), boron trifluoride etherate (BF₃OEt₂), and N,N-Diisopropyethylamine (DIPEA). In this example, the four R groups are methyl groups and forms bis[(difluoroboryl)dimethylglyoximato]cobalt(II) abbreviated as CoBF. CoBF may be synthesized, for instance, with an acceptable yield of 60%.

FIG. 3B illustrates a method for using the Co-based catalyst (e.g., CoBF) to form and analyze the photopolymer. In this example, the monomer is methacrylated sebacic acid (MSA). Commercially available BAPO (bis(2,4,6-trimethylbenzoyl)-phenylphosphineoxide) is used as the photoinitiator to generate the free radicals active in the polymerization. The resulting polymer may then be degraded with water and lyophilized to yield a terminated-poly(methacrylic acid) (t-PMAA). The t-PMAA may be converted to t-PMMA and analyzed by size exclusion chromatography (SEC). The concentration of the CoBF can be varied during the photopolymerization step to form photopolymers with varying mechanical properties.

In some embodiments, a method of using a Co-based catalyst to synthesize a photopolymer is provided. The method comprises providing a cobaloxime catalyst at concentrations less than 10,000 ppm, providing a photoinitiator, providing one or more methacrylate monomers, and subjecting the mixture to a light source whose wavelength and intensity are tailored to create free radicals by dissociation of the photoinitiator.

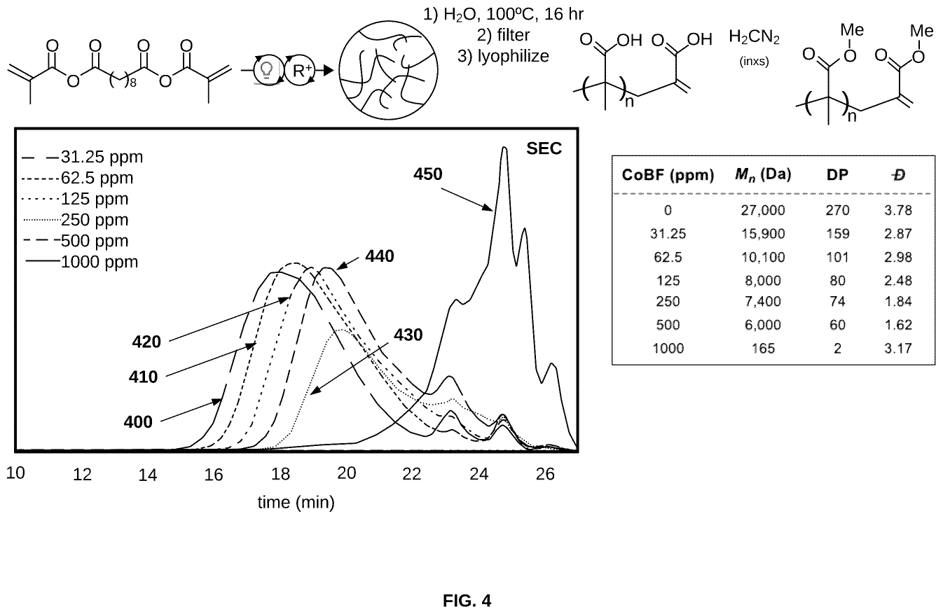

FIG. 4 presents analytical data of photopolymers prepared using the methods discussed with respect to FIGS. 3A and 3B. The concentration of CoBF was varied from 0 ppm to 1000 ppm (trace 400 is 31.25 ppm, trace 410 is 62.5 ppm, trace 420 is 125 ppm, trace 430 is 250 ppm, trace 440 is 500 ppm, trace 450 is 1000 ppm). In the absence of CoBF (0 ppm-no trace shown), the resulting photopolymer had an average molecular weight (Mn) of 27,000 Da, a degree of polymerization (DP) of 270, and a dispersity ( [symbol] ) of 3.78 as shown in the table. As the concentration of CoBF is increased from 31.25 ppm to 500 ppm, all three metrics decrease in a controllable manner. The sample with 1000 ppm CoBF, 450, did not gel and simply formed low molecular weight oligomers, as indicated in FIG. 4. These data confirm that Co-based complexes may catalytically reduce the kinetic chain length and the XLD of photopolymers derived from methacrylates.

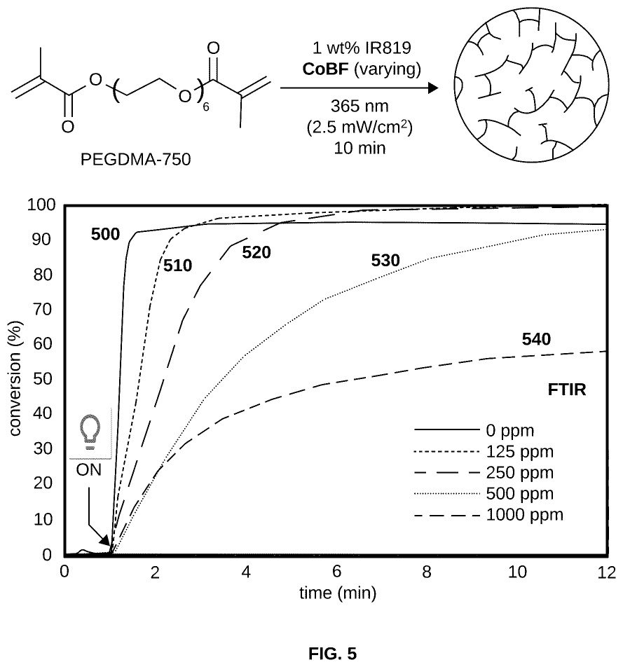

FIG. 5 presents analytical data of additional photopolymers prepared using the methods discussed with respect to FIGS. 3A and 3B. These photopolymers were synthesized using poly(ethylene) glycol dimethacrylate (PEGDMA) as the methacrylate monomer. The concentration of CoBF was again varied from 0 ppm to 1000 ppm (trace 500 is 0 ppm, trace 510 is 125 ppm, trace 520 is 250 ppm, trace 530 is 500 ppm, trace 540 is 1000 ppm). FTIR is used to follow the conversions of the double bonds during the polymerization as a function of time. These data give an indication of the gelation of the network. Trace 500 (0 ppm CoBF) presents the double bond conversion efficiency and kinetics in the absence of a Co-based catalyst. As the concentration of the Co-based catalyst is increased from 125 ppm, (trace 510), to 500 ppm, (trace 530), there is a delay in the gelation of the photopolymer. This delay is similar to that noted for non-catalytic sulfur-based CTAs, however without the drawbacks of using sulfur-based CTAs. Similar to the data presented in FIG. 4, relatively high concentrations (1000 ppm) of the Co-based catalyst exhibit long delays in the gelation and a very low conversion efficiency of the double bonds. Thus, the data in FIG. 5 indicate that Co-based CTAs are about one hundred times more active than sulfur-based CTAs.

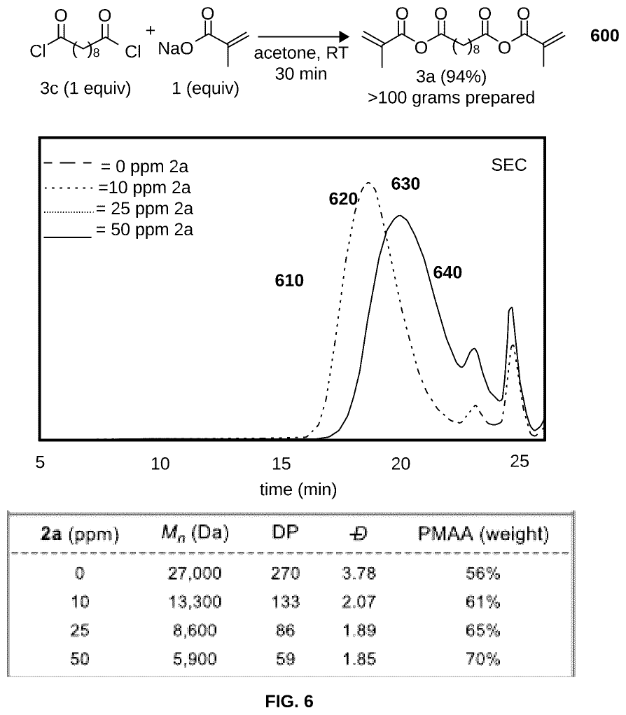

FIG. 6 presents analytical data of further photopolymers prepared using the methods discussed with respect to FIGS. 3A and 3B. These photopolymers were synthesized using methacrylated sebacic acid (MSA), 600. Initial results indicate that photopolymers synthesized using MSA would not gel at Co-based catalyst concentrations above about 500 ppm. The data presented in FIG. 6 indicate the influence of very low concentrations (0 ppm to 50 ppm) of the Co-based catalyst on the material properties of the resulting photopolymers (trace 610 is 0 ppm, trace 620 is 10 ppm, trace 630 is 25 ppm, trace 640 is 50 ppm). In the absence of CoBF (0 ppm), the resulting photopolymer had an average Mn of 27,000 Da, a DP value of 270, and a dispersity of 3.78. As the concentration of CoBF is increased from 10 ppm to 50 ppm, all three metrics decrease in a predictable manner. These data also indicate that the efficiency of the polymerization, as indicated by the PMAA weight increases at higher Co-based catalyst concentrations.

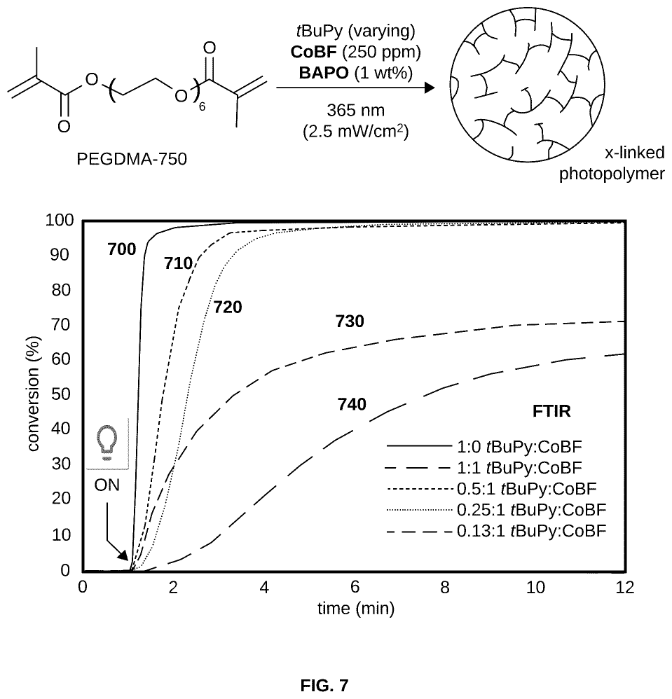

The Co-based catalysts discussed above have loosely coordinated axial ligands that may be readily displaced by more strongly sigma-donating ligands. The identity of the ligands also impacts the activity of these catalysts. FIG. 7 presents analytical data of photopolymers prepared using the methods discussed with respect to FIGS. 3A and 3B. Photopolymers were synthesized using PEGDMA in the presence of 250 ppm of CoBF, as discussed previously. These experiments utilized phenylbis(2,4,6-trimethylbenzoyl)phosphine oxide (BAPO) as the photoinitiator. 4-tert-butylpyridine (tBuPy) was added in varying amounts as a sigma-donating ligand. FIG. 7 presents Fourier Transform Infrared (FTIR) spectroscopy data following the conversion efficiency and kinetics of the double bond conversion as the ratio between the (tBuPy) ligand and CoBF is changed (trace 700 is a 1:0 ratio, trace 710 is a 0.5:1 ratio, trace 720 is a 0.25:1 ratio, trace 730 is a 0.13:1 ratio, trace 740 is a 1:1 ratio). Trace 700 indicates the polymerization in the absence of CoBF. Trace 740 indicates the polymerization where the ratio between the (tBuPy) and CoBF is 1:1. This trace indicates that both gelation and double bond conversion are suppressed at this ratio. Ratios between 0.5:1 and 0.25:1 (traces 710 and 720) indicate rapid gelation and high conversion efficiency. Further reduction of the ratio to 0.13:1 (trace 730) again suppressed gelation and indicated poor conversion. Therefore, the identity and concentration of sigma-donating ligands included during the polymerization may be used as additional parameters to tailor the use of Co-based catalysts in the synthesis of photopolymers.

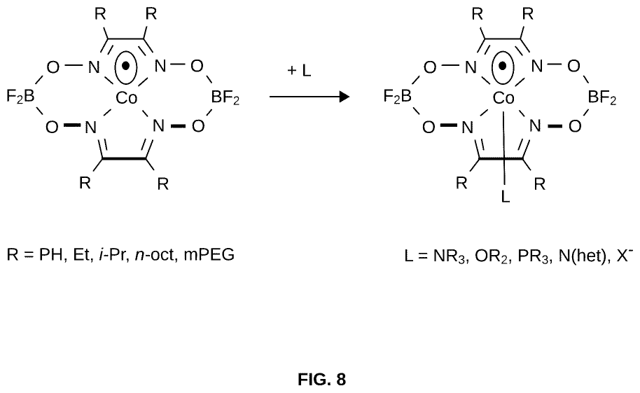

FIG. 8 illustrates opportunities to tailor the activity and performance of the Co-based catalysts through the selection of the R groups and ligands. As discussed previously, properties such as solubility, stability, and activity of the Co-based catalysts can be controlled by the proper selection of the R groups during their synthesis. A few R groups are listed in FIG. 8, including phenyl (Ph), ethyl (Et), isopropyl (i-Pr), n-octane (n-oct), and poly(ethylene glycol) methyl ether (mPEG). It is noted that this list is not intended to be exhaustive and that other R groups may be contemplated and are considered a part of the present disclosure. As discussed previously, in some embodiments, all the R groups may be the same. In some embodiments, some of the R groups may be different from each other.

FIG. 8 also indicates the interaction of various ligands with the Co-based catalyst as discussed with respect to FIG. 7. A few ligands are listed in FIG. 8, including amine (NR₃), ether (OR₂), thioether (SR₂), keto (O═CR₂), phosphine (PR₃), phosphine oxide (O═PR₃), phosphite (P(OR)₃, N-heterocyclic (N(het)), and halide (X⁻), among others. It is again noted that this list is not intended to be exhaustive and that other ligands may be contemplated and are considered to be a part of the present disclosure. In some embodiments, there may be more than one type of ligand species present during the photopolymerization step.

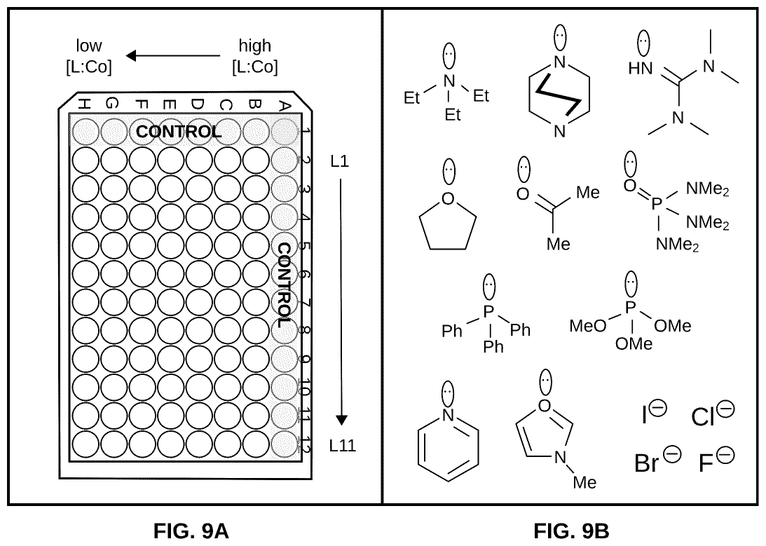

FIGS. 9A and 9B illustrate a scheme for the high throughput synthesis and analysis of photopolymers formed using Co-based catalysts. In particular, FIG. 9A shows an exemplary 96 well plate arrangement suitable for use with certain embodiments. FIG. 9B shows examples of different ligands that may be evaluated using the arrangement as shown in FIG. 9A. As discussed previously, a thorough investigation of the photopolymerization parameter space is expensive in terms of time, materials, analytical equipment, and manpower. High throughput well plates can be used for initial screening experiments to identify concentration regions and sub-species identity before expending time and material on the synthesis of larger batches for bulk analysis.

As shown in FIG. 9A, a 96 well plate may be used to implement an experiment where the identity and concentration of various ligands may be tested. In the illustrated example, within each well, the concentrations of the MMA monomer, photoinitiator, and Co-based catalyst may be held constant, while eleven different ligands (such as shown in FIG. 9B) may be evaluated in this scheme. For example, column A may serve as a control, with the highest loading of each ligand type and no Co-based catalyst. Thus, the wells of column A should result in the typical photopolymerization without the use of the catalysts discussed herein. Row 1, for example, may be a control that has no ligands present, but increasingly lower concentrations of the Co-based catalyst. Cell A1 may include no Co-based catalyst nor ligand and may serve as a negative control. The cells may be filled using typical chemical dispensing techniques. The entire plate can then be processed to form and analyze the resulting photopolymers. For instance, the degree of crosslinking may be inferred by including luminophore additives that change the intensity of their emission as a function of the crosslinking of the photopolymer. Such a scheme as shown in FIGS. 9A and 9B allows rapid screening of the Co-based catalyst-ligand parameter space without having to generate bulk samples for each possible combination.

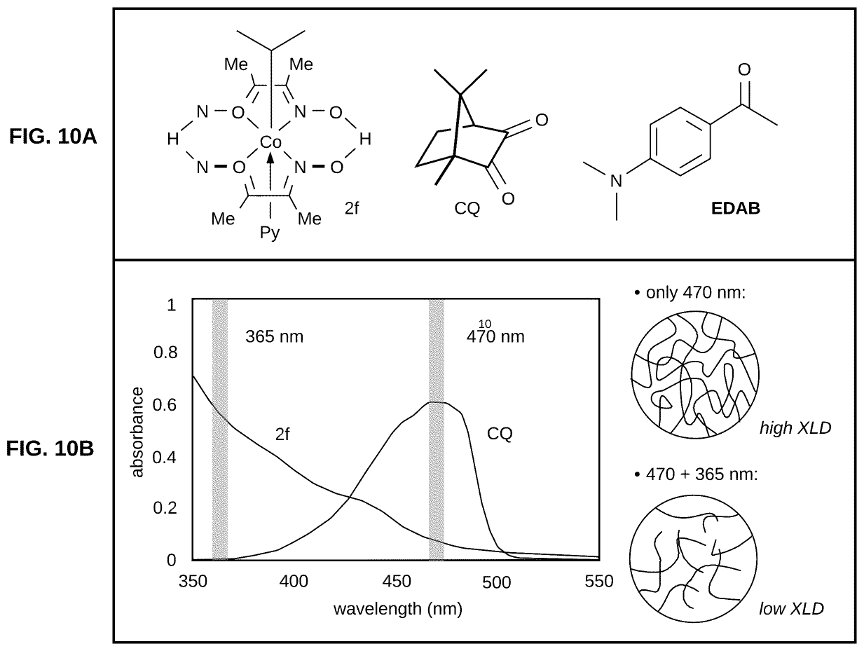

The Co-based catalysts discussed above may be based on Co(II) complexes that are active during the photopolymerization process. Similar Co(III) complexes may not be active and not exhibit catalytic function. FIGS. 10A and 10B illustrates a process whereby inactive Co(III) complexes can be activated using light to generate active Co(II)-based catalysts in-situ. In particular, FIG. 10A illustrates an exemplary photoinitiation system, according to certain embodiments. FIG. 10B includes an exemplary graph of the absorbance as a function of wavelength for different wavelengths used during photopolymerization.

As shown in FIG. 10A, an inactive Co(III) catalyst may be used in the photopolymerization process as discussed previously. In this scheme, a photoinitiation system active in the visible light region is used. As an example, camphorquinone (CQ) and tertiary amine (ethyl 4-(dimethylamino)benzoate) (EDAB) may be used as the photoinitiator to generate the free radicals. This photoinitiation system works well at applied wavelengths of about 470 nm. The photolysis of cobalt-carbon bonds in cobaloximes has been well studied at wavelengths below 420 nm. When this system is exposed to light at a wavelength of about 470 nm, the Co(III)-based catalyst is inactive and the process results in a highly crosslinked photopolymer, as indicated by a curve labeled CQ in FIG. 10B. When this system is exposed to light at dual wavelengths of about 470 nm and about 365 nm, the Co(III)-based catalyst may be activated to form an active Co(II)-based catalyst and the process results in a photopolymer with reduced crosslink density (XLD) and different material properties from the photopolymer formed using only light of 470 nm wavelength, as indicated by a curve labeled 2f in FIG. 10B as well as in the circular insets showing simplified illustrations of high XLD achieved using only exposure to 470 nm as compared to low XLD achieved using a dual wavelength exposure at 470 nm and 365 nm.

This dual-wavelength scheme may be used to generate a photopolymer with spatially different material properties from the same input material by simply changing the wavelength(s) applied during the photopolymerization process. As an example, a photopolymer product piece may be manufactured wherein portions of the product piece include a highly crosslinked, brittle polymer (e.g., exposed to 470 nm wavelength light only) and other portions of the product piece are formed as a lower crosslinked, tougher polymer (exposed to, for example, 365 nm and 470 nm wavelength light during photopolymerization). This method may be used to generate active catalyst with spatial control. Alternatively, these species may also be generated in situ throughout the bulk of the material by reduction of a macrocyclic cobalt(III) complex by photolysis or by an addition-fragmentation mechanism (such as S_{H}2 mechanism) with an external source of free radicals.

The cobalt-based catalytic CTAs may be used, for example, to reduce volumetric shrinkage and shrinkage stress in crosslinked photopolymers primarily utilized in additive manufacturing (i.e., 3D printing) and dentistry (such as in bis-GMA/TEGDMA resins). Further, the CTAs described above may be used to increase the efficiency and intensity of actuation in liquid crystal actuators and liquid crystal displays formed using photopolymeric methods. Further, the catalytic CTAs described above may be modified to tunably alter the mechanical properties of a commercial resin catalytically without changing the monomer formulation. Such material tunability may have applications in a variety of fields, such as adhesives, protective coatings (such as for optical fiber manufacturing), additive manufacturing resins, and bulk photopolymers, among other uses.

An improved catalyst enables the synthesis of heretofore unavailable materials and new uses thereof. For example, a large ratio of chain transfer agents to bulk volume (e.g., 10 to 20 wt % or more) of thiols and other catalytic transfer agents may be required for catalytic effect such that diffusion of the catalyst is not a concern, although the material properties of the resulting photopolymer is highly influenced by the material properties of the catalyst agent.

As described above, cobalt-based CTAs achieve improved effects with a 10,000× lower loading by ratio to the bulk volume compared to previously available CTAs. That is, due to the consumption of thiol-based CTAs during the polymerization and the low chain transfer coefficient, large concentrations (e.g., 10 to 20 wt %) of the CTAs are required. As these CTAs are employed in large concentrations, diffusion of the agent is rarely considered in these cases. However, sufficient and uniform diffusion of the CTA greatly affects the material properties of the resulting material after photopolymerization.

While Co(II) catalysts such as CoBF are known to be able to adequately diffuse in a rubbery system, Co(II) catalysts has more difficulty in uniformly diffusing throughout a glassy/viscous system. Embodiments of catalysts improvement described herein may be scalable and have generally better resin solubility and require a reduced ratio of catalyst to the bulk material. In other words, resins including commercial monomers with a catalyst will result in new materials with new uses. If the cobalt-based CTA may be made to efficiently diffuse through the bulk material network during photopolymerization, the catalytic cobalt-based CTA will function as an effective chain transfer agent.

Further, tailoring the processing conditions during photopolymerization modulates the diffusion of the catalyst within the bulk material, thus controlling the catalyst activity and creating unique mechanical properties of the crosslinked photopolymeric material, especially with formulations that result in glassy (T_{g}>RT) materials or otherwise viscous resins. The processing condition parameters may include, for example, use of diluents, altering the temperature of the resin during photopolymerization, light intensity used in the photo-curing process, and choice of reactive functionality, such as choosing between acrylate and methacrylate in the bulk material. In this way, the cured photopolymer may be selected to exhibit a variety of material properties by, for example: 1) choosing a specific formulation of the bulk photopolymeric material; 2) choosing a formulation of a given bulk photopolymeric resin with a selected catalyst transfer agent; 3) using a given formulation of a bulk photopolymeric material with a catalytic chain transfer agent, altering the formulation with a diluent (either reactive diluent or non-reactive); 4) using a given formulation of a bulk photopolymeric resin with a catalyst transfer agent, with or without a diluent, modifying the curing conditions; and 5) alteration of temperature of the resin to increase diffusion of catalyst.

For instance, a resin that creates a glassy photopolymeric material (T_{g}>RT), may be modified by CTA selection, diluent selection, and/or cure conditions to produce a cured material with rubbery properties. In other words, the embodiments described herein enable heretofore unavailable flexibility in obtaining a photopolymer with desired material characteristics, such as by:
1) specifically formulating the bulk photopolymeric material;
2) combining a given bulk photopolymeric material with a catalytic chain transfer agent;
3) diluting a formulation of a bulk photopolymeric material and a catalyst transfer agent with a reactive or non-reactive diluent; and
4) given a specific formulation of a photopolymeric material, catalytic transfer agent, and/or diluent, modifying the cure conditions (e.g., light intensity and applied temperature of polymerization).

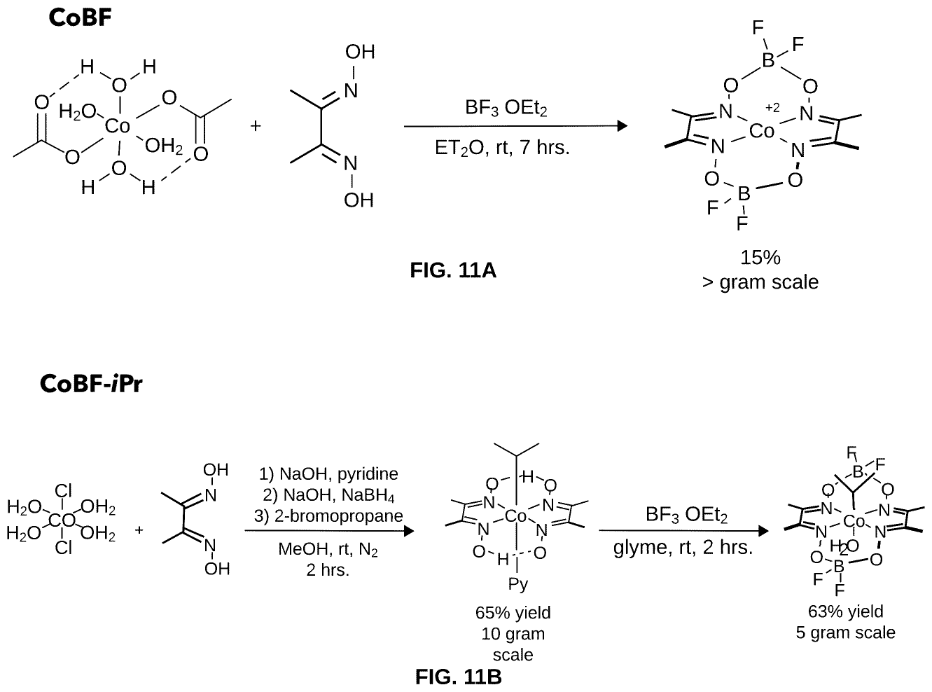

FIGS. 11A and 11B illustrate examples of Co(II) and Co(III) complexes suitable for use in certain embodiments. Whereas the use of cobalt-based catalysts such as CoBF, which is a Co(II) complex, have been discussed in detail above, it is recognized herein that a Co(III) complex, such as CoBF-iPr, may provide similar catalytic effects with further advantages, such as improved yield, increased solubility, and simplified characterization. For instance, it is speculated that Co(III) generates Co(II) in situ via a mechanism such as photolysis such that, when used as a catalyst transfer agent, a Co(III) complex may provide similar effect to a Co(II) complex in promoting catalyst activity during photopolymerization.

In particular, FIG. 11A shows a simplified synthesis process of CoBF, in accordance with an embodiment. Similarly, FIG. 11B shows a simplified synthesis process of CoBF-iPr, in accordance with an embodiment.

As noted in FIG. 11A, CoBF may only be produced at a gram scale or less with an overall yield of 15%. In contrast, CoBF-iPr may be scalably produced at 5-gram scale or greater with an improved overall yield of 41% while providing similar reactivity to known Co(II) complexes. Furthermore, CoBF-iPr may be characterized with simpler procedures (e.g., using nuclear magnetic resonance (NMR) spectroscopy), without requiring ultraviolet (UV)/visible (vis) spectroscopy. Additionally, CoBF-iPr exhibits improved solubility in polymerizable resins, such as dodecyldimethylamine (DDMA) resin.

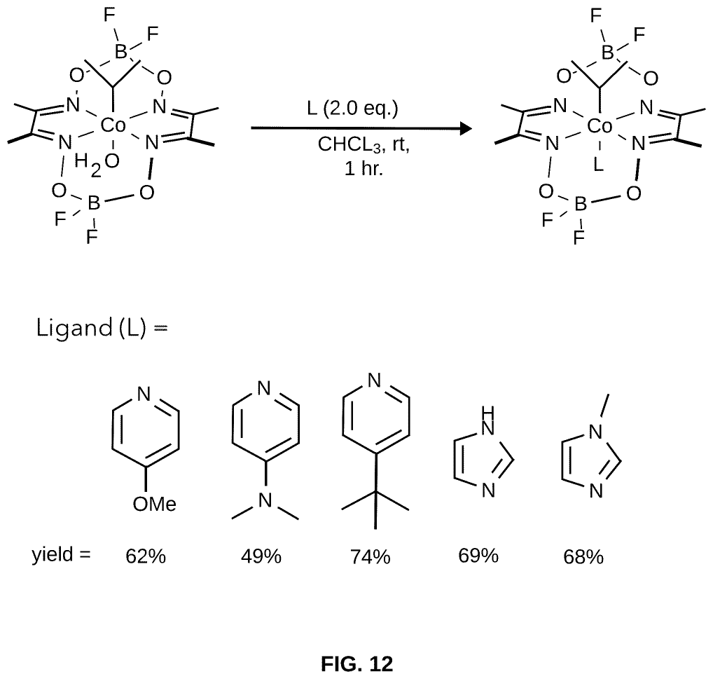

Further, new catalysts may be developed based on Co(III) complexes, such as CoBF-iPr-ligand complexes, by tuning the specific ligands attached to available sites of a CoBF-iPr molecule. FIG. 12 illustrates examples of a Co(III) complex and variations suitable for use in certain embodiments. For example, certain ligands may improve resin solubility in a bulk material (such as in polydimethylsiloxane (PDMS)) and other parameters.

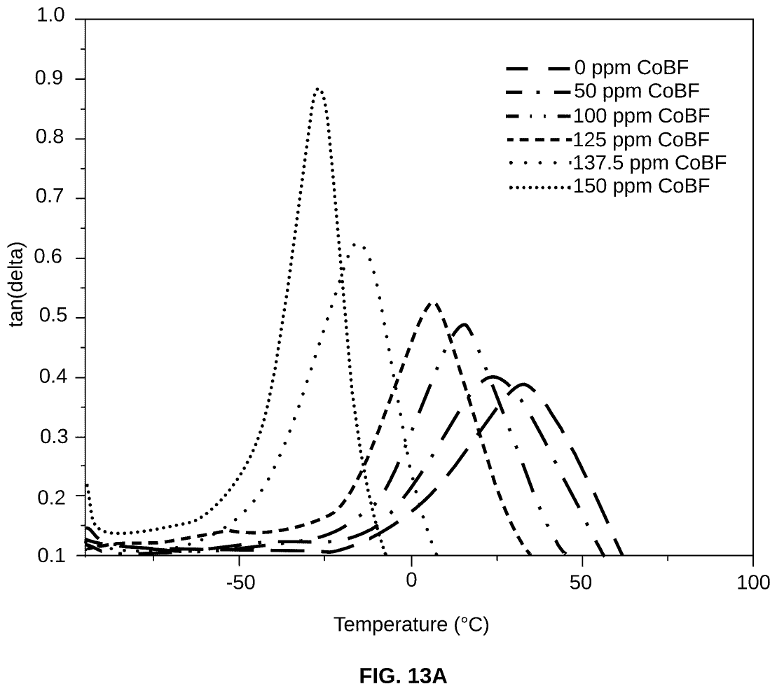

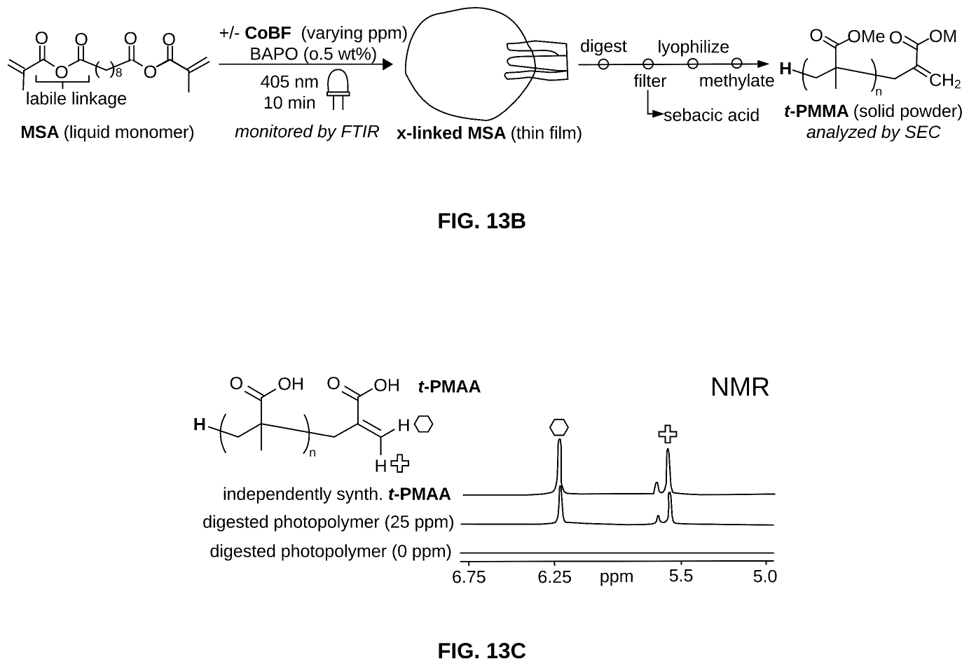

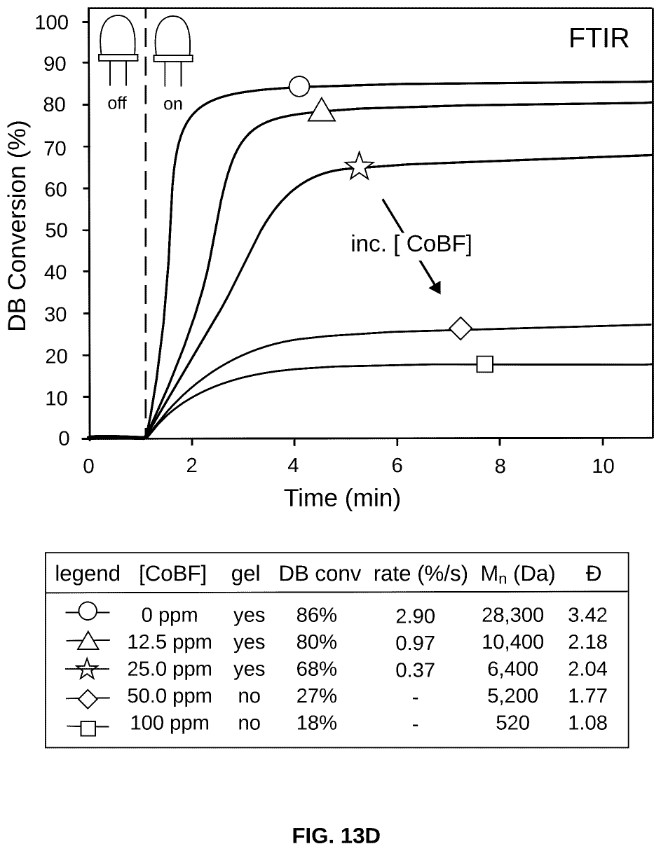

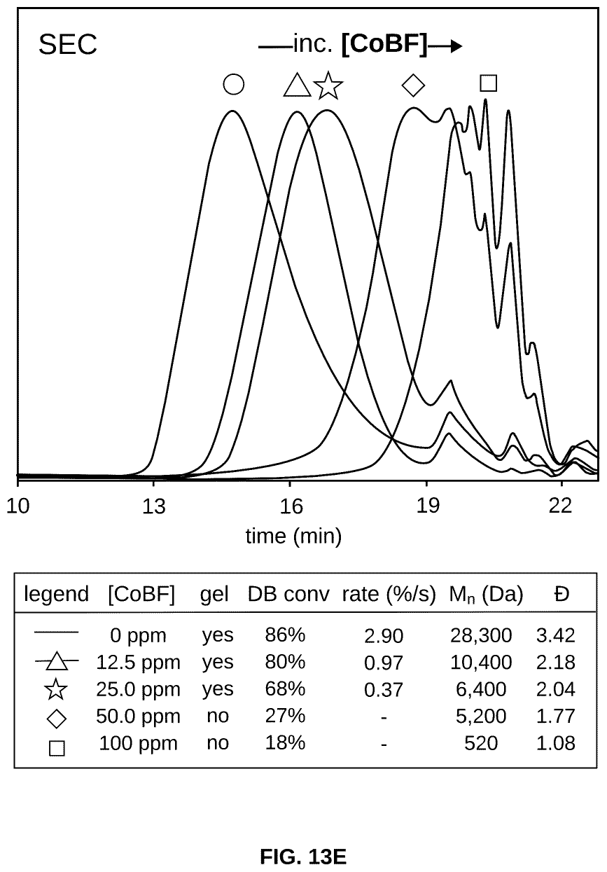

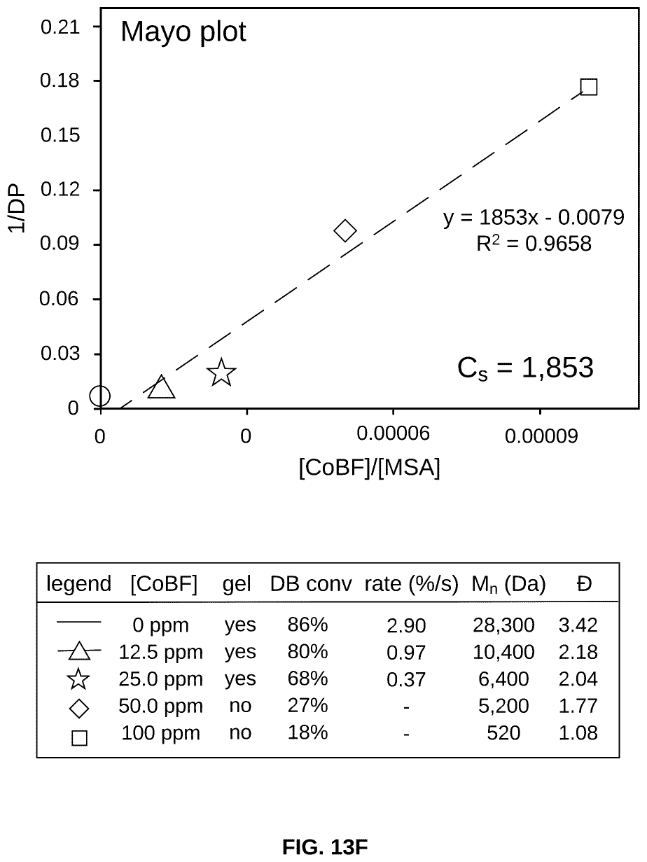

The effects of a Co-based catalyst on the mechanical properties of a given crosslinked photopolymeric material may be analyzed, for example, in terms of induced changes in the glass transition temperature. For example, FIG. 13A shows experimental results illustrating the effect of different loads of an exemplary Co(II) complex on the glass transition temperature for a rubbery photopolymer system (T_{g} of native photopolymer=^{˜}30° C.).

A Co(II) complex may sufficiently diffuse in a rubbery system to provide efficient catalytic effects during photopolymerization, even with just a few parts per million within a bulk material (0-150 ppm in FIG. 13A). For instance, a rubbery system formulated with 90 wt % of Polyethylene glycol dimethacrylate (PEGDMA)-550 and 10 wt % of methyl methacrylate (MMA) with a photoinitiator Bis(2,4,6-trimethylbenzoyl)phenylphosphine oxide (BAPO) (0.5 wt %) exhibits an initial glass transition temperature (T_{g}) of approximately 34° C. When the system is modified with varying amounts of CoBF added thereto, the inclusion of even 150 ppm of CoBF resulted in a 61° C. change in T_{g} under the same curing and processing conditions (405 nm wavelength light at 10 mW/cm² for 10 minutes).

Alternatively, FIGS. 13B-13F in the paper shows the workflow for determining the impact of the catalyst to reduce the internal kinetic chain length of the polymer, reduce crosslinking density, shows extrapolation of chain transfer coefficient (Cs) for the given catalytic CTA, and proves that catalyst is operating by terminating the internal polymer chain by forming a terminal alkene. FIG. 13B shows the workflow of photopolymerization of methacrylated sebacic acid (MSA) into a thin film which can be digested by refluxing in water. As may be seen in FIG. 13B, removal of sebacic acid by filtration, lyophilization, and exhaustive methylation resulted in an alkene-terminated poly(methyl methacrylate) (t-PMMA), which is directly analyzable by NMR spectroscopy and SEC analysis. FIG. 13B also includes overlayed NMR spectroscopy results of t-PMAA showing alkene termination of the polymer chain in the presence of CoBF and no alkene termination in the absence CoBF, compared to independently synthesized t-PMAA. The small peak at 5.64 ppm was presumed to arise from the isomerization of the alkene internally.

FIG. 13C shows representative FTIR and SEC data showing the effect of CoBF loading on the polymerization. Further, FIG. 13D shows a FTIR kinetic plot of the photopolymerization of MSA in the presence of varying loadings of CoBF (given photopolymerization conditions of light energy at 365 nm, ˜10 mW/cm², with continuous irradiation for one minute).

FIG. 13E is a composite SEC plot, showing reduced molecular weight with increased loadings of CoBF. FIG. 13F shows a Mayo plot of the SEC data, where CoBF was calculated to have a chain transfer coefficient (Cs) of 103.

However, the inclusion of CoBF in a glassy system may not result in similar modifications of the T_{g}, likely due to the reduced diffusion efficiency of CoBF in such systems. For this reason, alternative processing conditions such as increasing the temperature of polymerization or reduction of viscosity are necessary to obtain catalyst activity and, therefore, have alteration of mechanical performance of the ultimate crosslinked photopolymeric materials.

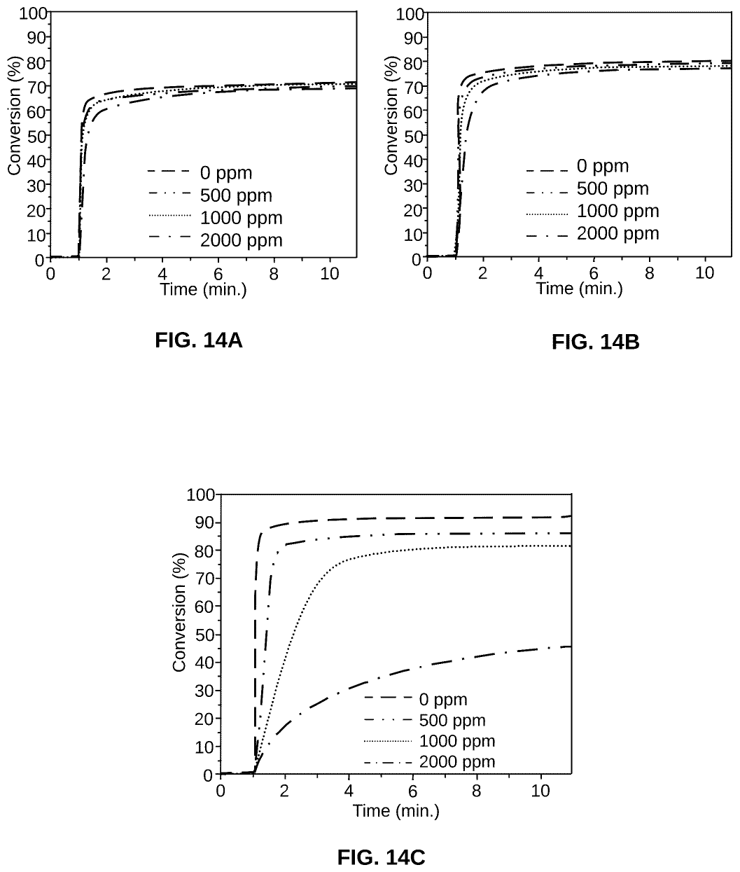

FIGS. 14A-C show experimental results illustrating the effect of different concentrations of an exemplary Co(III) complex on the conversion percentage and rate for a glassy photopolymer system, cured at a cure temperature of ° C. In the example illustrated in FIGS. 14A-C, the glassy formulation includes 70 wt % of urethane dimethacrylate (UDMA) and 30 wt % of diethylene glycol dimethacrylate (DEGDMA), which generally exhibits a glass transition temperature T_{g} of 212° C. natively.

The curves representing conversion percentage as a function of time when the system is cured at 25° C. (FIG. 14A) and when the system is cured at 50° C. (FIG. 14B) for various concentrations of CoBF-iPr (ranging from 0 ppm to 2000 ppm) result in similar final double bond conversions (^{˜}70% for FIG. 14A [cured at 25° C.] and ^{˜}80% for FIG. 14B [cured at 50° C.]).

That is, at these lower cure temperatures of 25° C. and 50° C., the polymerization essentially occurs as a delta function when the light energy is turned on at around 1 minute from the start of the cure process such that the resulting material is substantially and immediately glassy after a one-minute cure time. In other words, the light energy initiates the photopolymerization process, independent of the cure temperature, showing that the elevated temperature does not form free radicals at an appreciable rate to start the polymerization before application of light energy.

FIG. 14C shows the conversion percentage as a function of time when the system is cured at 100° C. for various concentrations of CoBF-iPr, again ranging from 0 ppm to 2000 ppm. As may be seen in FIG. 14C, the conversion percentage as a function of time at this elevated temperature changes dramatically for different concentrations of the Co(III)-based catalyst. For example, at the highest CoBF-iPr concentration of 2000 ppm shown in FIG. 14C, the photopolymerization takes place at reduced rates than at lower cure temperatures. In this way, the resulting material does not achieve the similar level of polymerization conversion as at lower cure temperatures, thus creating materials with vastly different crosslinking densities and, therefore, mechanical properties.

That is, for glassy systems, the incorporation of the Co(III)-based catalyst transfer agent with an increased cure temperature results in increased catalyst activity, likely due to efficient diffusion of the catalyst through the network during photopolymerization. Particularly, it is speculated that the increased diffusion of the Co(III)-based catalyst with elevated cure temperatures results in the photopolymerization process moving from a traditional chain-growth photopolymerization to a “step-growth”-like polymerization process, unlocking materials with lower crosslinking density and, therefore, mechanical properties not previously accessible with these monomers under photopolymerization conditions. Such dependence of the catalyst activity as a function of the cure temperature (and other cure parameters) may be utilized to tailor the mechanical properties of the photopolymer during the photopolymerization process.

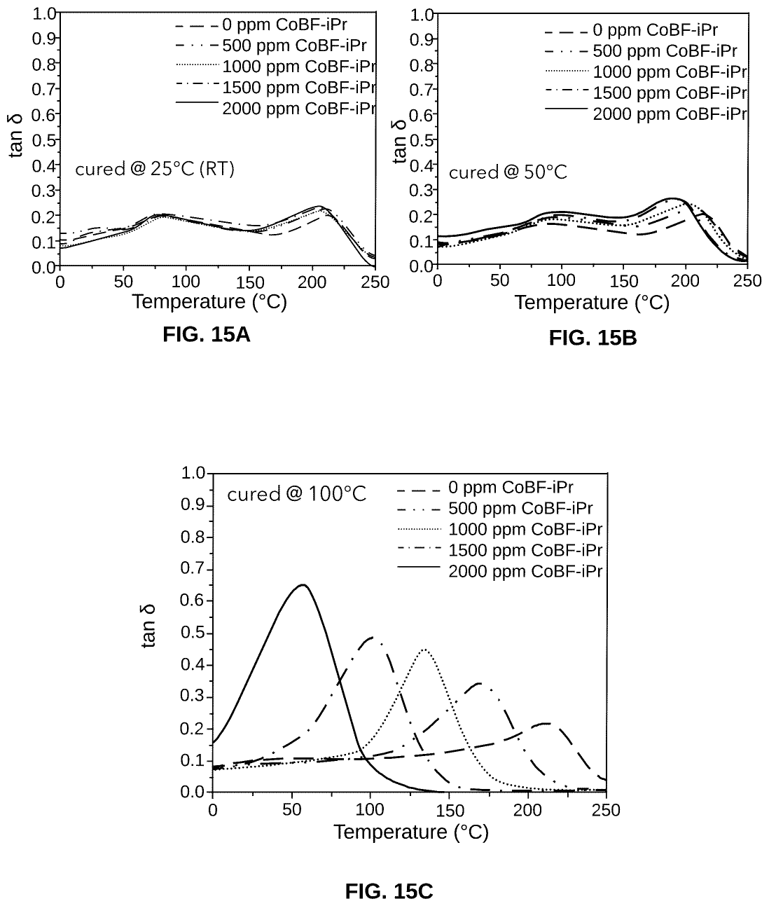

In addition to the conversion rate and final double bond conversion, the glass transition temperature for a glassy material may be tailored by modifying the cure temperature. FIGS. 15A-C show experimental results illustrating the effect of different loads of an exemplary Co(III) complex on the glass transition temperature for a glassy photopolymer system, with the rest of the curing conditions remaining the same as the conditions used to generate the graphs in FIGS. 13-14C.

Particularly, FIG. 15A shows the measured tan δ as a function of temperature when the system is cured at 25° C. (RT). FIG. 15B shows the measured tan δ as a function of temperature when the system is cured at 50° C. FIG. 15C shows the measured tan δ as a function of temperature when the system is cured at 100° C. The peak of the measured tan δ curve generally corresponds to the glass transition temperature.

As may be seen in FIGS. 15A and B, the inclusion of CoBF-iPr does not significantly alter the glass transition temperature of the material, with the highest peak of measured tan δ remaining at above 200° C. at these lower cure temperatures across different concentrations of the Co(III)-based catalyst transfer agent. However, when the cure temperature is raised to 100° C., increased concentrations of CoBF-iPr result in significant reduction in the glass transition temperature. For example, as may be seen in FIG. 15C, the inclusion of 2000 ppm of CoBF-iPr results in the reduction of the measured tan δ peak to around 60° C. It is speculated that the effectiveness of a catalyst may be greatly improved by the elevated cure temperature, as the rate of diffusion of the catalyst through the network during photopolymerization is increased. Such effects are more pronounced in using cobalt-based catalytic chain transfer agents due to the small quantities (on the order of tens to hundreds of parts-per-million) used within the photopolymer compared to when thiols and other CTAs are used with a photopolymer. That is, since thiols and other CTAs take up much more free volume than (e.g., 10,000-times more) than Co-based CTAs, diffusion plays a much smaller role in influencing chain transfer activity for previously known thiols and CTAs compared to for a Co-based CTA.

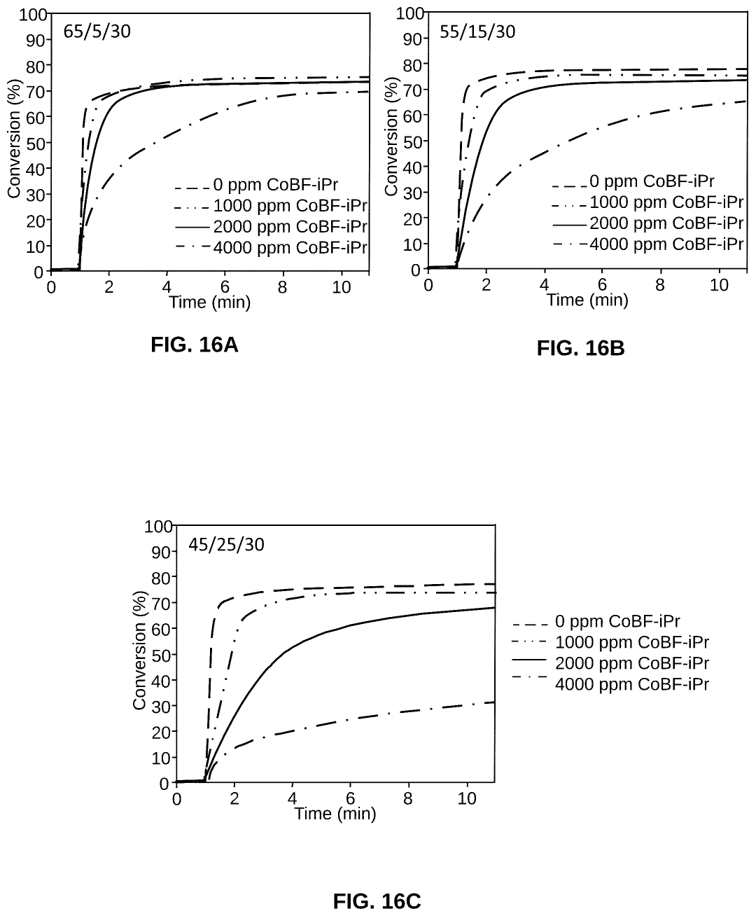

Another potential “knob” for use in tailoring the material properties of a photopolymer is the addition of a reactive or non-reactive diluent. FIGS. 16A-C show experimental results illustrating the effect of reactive diluent concentration on the rate and final double bond conversion including 30 wt % of TEDGMA with varying ratios of urethane dimethacrylate (UDMA) and diethylene glycol dimethacrylate (DEGDMA). It is noted that UDMA exhibits relatively high viscosity in comparison to the rubbery photopolymers discussed above. Therefore, adding less viscous diluents, whether reactive or non-reactive, in controlled amounts into the formulation may enable the tailoring of the material properties of the cured photopolymer by way of altering the diffusion of the catalyst during the photopolymerization.

Particularly, FIG. 16A shows the conversion percentage for different concentrations of CoBF-iPr as a function of time when the system includes 65 wt % of UDMA, 5 wt % of DEGDMA, and 30 wt % of TEDGMA. FIG. 16B shows the conversion percentage as a function of time when the system includes 55 wt % of UDMA, 15 wt % of DEGDMA, and 30 wt % of TEDGMA. FIG. 16C shows the conversion percentage as a function of time when the system includes 45 wt % of UDMA, 25 wt % of DEGDMA, and 30 wt % of TEDGMA. Again, the cure conditions were substantially similar to those used for FIGS. 13-15C, other than different concentration values of CoBF-iPr catalyst transfer agent.

As visible across FIGS. 16A-C, at higher catalytic CTA loads, such as at 2000 ppm and 4000 ppm, increased reactive diluent concentration results in a reduction of conversion rate curve. It is speculated that, as reactive diluent concentration is increased, the viscosity of the formulation decreases before and during the photopolymerization, thus resulting in higher catalyst diffusion, and therefore, activity. In other words, the combination of the Co(III)-based catalyst transfer agent concentration and reactive diluent concentration enables additional control over the material properties of the photopolymeric material.

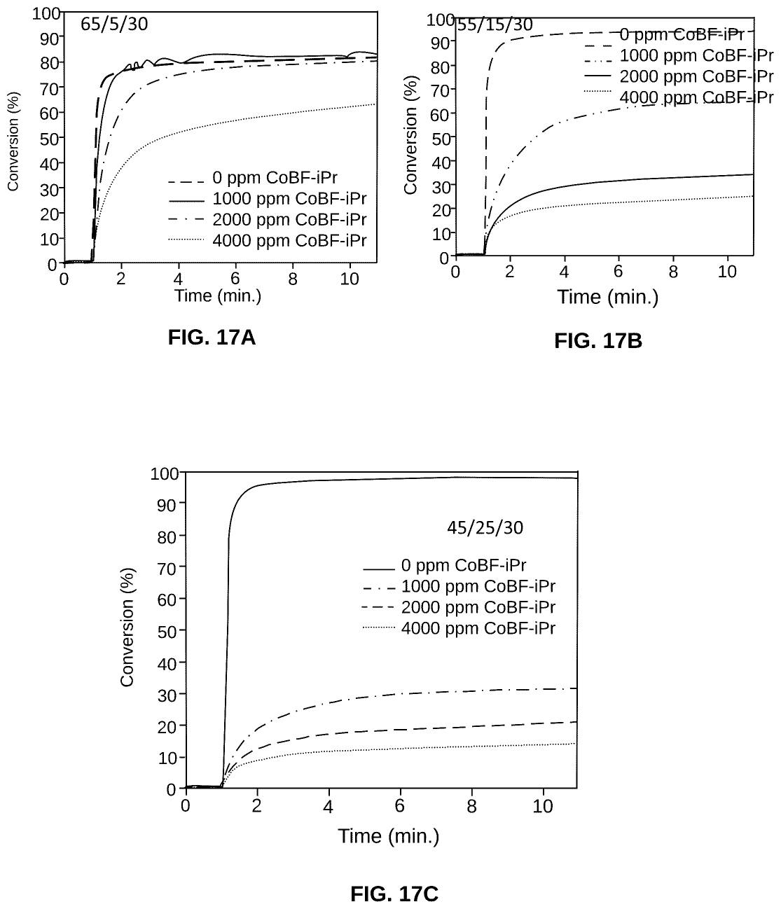

Similar effects may be observed using a non-reactive diluent, such as diethylene glycol dimethyl ether (DEGDME) in the formulation. For example, FIGS. 17A-C show experimental results illustrating the effect of non-reactive diluent concentration on the conversion percentage for a glassy photopolymer system including 30 wt % of TEDGMA with varying ratios of UDMA and DEGDME. Particularly, FIG. 17A shows the conversion percentage for different concentrations of CoBF-iPr as a function of time when the system includes 65 wt % of UDMA, 5 wt % of DEGDME, and 30 wt % of TEDGMA. FIG. 17B shows the conversion percentage as a function of time when the system includes 55 wt % of UDMA, 15 wt % of DEGDME, and 30 wt % of TEDGMA. FIG. 17C shows the conversion percentage as a function of time when the system includes 45 wt % of UDMA, 25 wt % of DEGDME, and 30 wt % of TEDGMA. The cure conditions used in generating the graphs of FIGS. 17A-C are otherwise identical to those used to generate FIGS. 16A-C.

As may be seen in FIGS. 17A-C, inclusion of different concentrations of non-reactive diluents in the formulation significantly influence the conversion rate and final double bond of the photopolymer, particularly when supplemented with Co(III)-based catalyst transfer agents. As with the case of the reactive diluents discussed above in FIGS. 16A-C, the inclusion of non-reactive diluents generally reduce the viscosity of the formulation before and during, thus improving the diffusion of the catalyst transfer agent throughout the photopolymeric material, thus resulting in increased catalyst activity and providing another parameter useful in adjusting the material properties of the cured photopolymer. It is particularly notable that the non-reactive diluents used in generating FIGS. 17A-C may have a stronger effect on the conversion rate, final double bond conversion and, therefore, mechanical property development in comparison to reactive diluents.

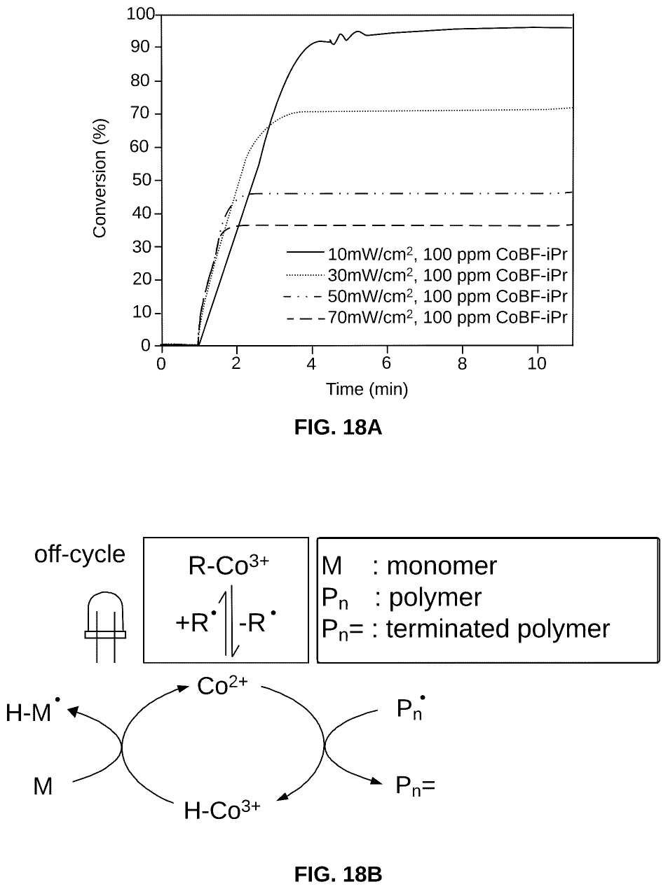

Another parameter that may be adjusted to further tailor the material properties of the photopolymer is the intensity of the light energy provided during the curing process, with other parameters such as the catalyst transfer agent concentration, wavelength of light, and dose being the same. FIG. 18A shows experimental results illustrating the effect of light intensity for a given concentration of an exemplary Co(III) complex on the conversion percentage for a rubbery photopolymer system.

As may be seen in FIG. 18A, for the same concentration of CoBF-iPr (100 ppm) with BAPO (0.5 wt %) in the rubbery formulation of PEGDMA-550 (90 wt %) and MMA (10 wt %), increased light intensity during the cure process leads to a reduction of double bond conversion with an increase in the rate of double bond consumption as a function of time. Thus, for the same formulation, modifying the intensity of the light used during the cure enables significant variation in the material properties of the resulting photopolymer.

FIG. 18B illustrates an exemplary mechanism for the photopolymerization process that is affected by the modification of the light intensity used during the cure. As shown in FIG. 18B, during the cure process, R—Co³⁺ complexes are off-cycle such that the R—Co bond must be cleaved to enter the catalytic cycle. The application of higher light intensity during the cure process leads higher concentration of Co²⁺ on-cycle, thus resulting in a modification of the double bond conversion and an increased efficacy of the catalyst, with all other things held the same, as shown in FIG. 18A.

Another factor that may affect the photopolymerization process is the light energy provided during the cure. For example, the light intensity, wavelength (or combination of wavelengths), application time, and other characteristics of the light energy provided to the photopolymer in combination of the specifics of the catalyst influence the material properties of the cured material.

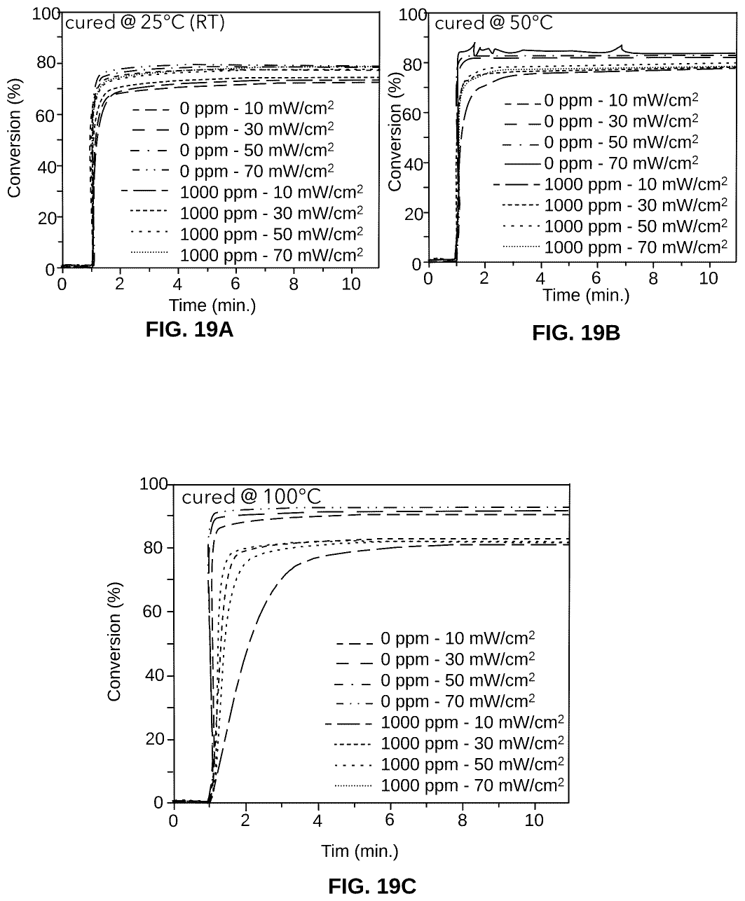

FIGS. 19A-C show experimental results illustrating the effect of light intensity and different loads of an exemplary Co(III) complex on the conversion percentage for a glassy photopolymer system. Particularly, FIG. 19A shows the conversion percentage as a function of time when the system is cured at 25° C. (RT) under different light intensity conditions and loadings of CoBF-iPr. As shown in FIG. 19A, when the curing process is performed at room temperature, the polymerization occurs with little difference in rate or final double bond conversion with and without CoBF-iPr catalyst provided into the material system.

As the curing temperature is raised to 50° C. and 100° C., however, a greater variation in the conversion rate and final double bond conversion begins to manifest. For instance, FIG. 19B shows the conversion percentage as a function of time when the system is cured at 50° C. under different light intensity conditions and loads of CoBF-iPr. FIG. 19C shows the conversion percentage as a function of time when the system is cured at 100° C. under different light intensity conditions and loads of CoBF-iPr. As may be seen in FIGS. 19B and C, the combination of a reduced intensity light energy in combination with smaller amounts of catalyst in this glassy system results in a more gradual conversion in the photopolymerization process.

It may be noted in FIGS. 19A-C that, for the same amount of catalyst introduced into the system, the reduction in light intensity during the cure process appears to lead to a more gradual photopolymerization, although ultimately the conversion rate converges at approximately the same percentage after about five minutes of light application. Thus, it is speculated that the increased diffusion of the catalyst through the network with the elevated cure temperature likely has a greater effect on the overall material properties of the cured, glassy photopolymer system, in comparison to the light intensity variation itself. Conversely, for rubbery systems or systems where high heat of polymerization, in which catalyst diffusion is less of an issue, the material properties of the cured photopolymer may be more susceptible to influence from variations in the light intensity during cure.

Still another parameter influencing the material properties of the cured photopolymer is the use of acrylates within the formulation. For example, reactive diluents may be added for a variety of reasons such as, and not limited to: 1) decreasing the viscosity of a given resin; 2) improving the workability of the resin; 3) reducing the price of the resin (e.g., monofunctional molecules are cheaper); 4) adding functional groups (hydrophobic, hydrophilic, hydrogen bonding, etc.) that would be otherwise difficult or impossible to add in the necessary concentrations on a multifunctional molecule; and 5) reducing crosslinking density/improve mechanical properties of ultimate material.

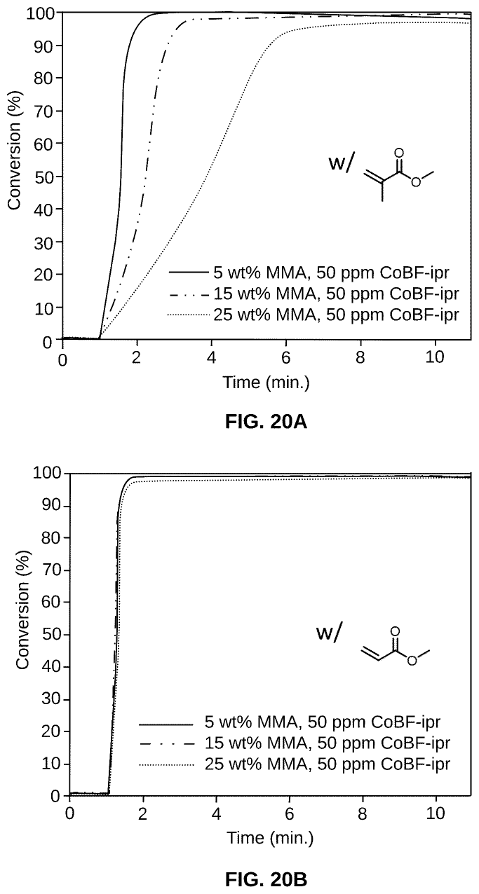

FIGS. 20A-B show experimental results illustrating the difference in the material property provided by including a methyl methacrylate (MMA) or a methacrylate (MA) as a reactive diluent in a rubbery photopolymer system. Particularly, FIG. 20A shows the conversion rate as a function of time when the system includes 50 ppm of CoBF-iPr and different ratios by weight of MMA. As may be seen in FIG. 20A, for the same amount of Co(III) complex and cure conditions, increased amounts of MMA included in the formulation leads to a variation the conversion rate during photopolymerization. Thus, MMA inclusion may be used as another parameter for tuning the characteristics of the resulting photopolymer.

In contrast, FIG. 20B shows the conversion rate as a function of time when the system includes 50 ppm of CoBF-iPr and different ratios by weight of MA. As may be seen in FIG. 20B, essentially no change in the conversion rate is seen even when the MA inclusion ratio is increased from 5 wt % to 25 wt %. That is, it appears that under otherwise the same cure conditions, the inclusion of MA suppresses catalyst activity, even with the inclusion of 50 ppm of a Co(III) complex catalyst such as CoBF-iPr.

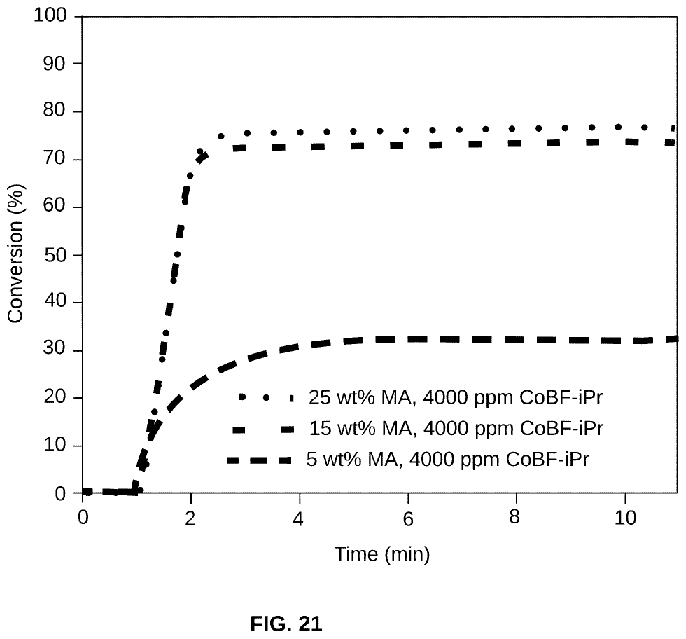

Yet, it is recognized herein that such effects of MA on catalyst activity in a rubbery photopolymer system may be overcome by the adjustment of another curing parameter, such as the light intensity and increased ratio of Co(III) catalyst. For instance, FIG. 21 shows experimental results illustrating the effect of light intensity and different loads of an exemplary Co(III) complex on the conversion percentage for a rubbery photopolymer system including a methacrylate. It is noted that acrylates may “poison” the catalyst such that, although some processing parameters ameliorate any negative effects on the catalyst, to some extent. In embodiments, it may be desirable to avoid the use of acrylates in photopolymer formulations where cobalt-based CTAs are intended to be used.

As may be seen in FIG. 21, for an increased ratio of catalyst (4000 ppm of CoBF-iPr in FIG. 21, compared to 50 ppm for FIGS. 20A and B) and a higher light intensity (70 mW/cm² in FIG. 21, compared to 10 mW/cm² in FIGS. 20A and B), there is increased catalytic activity at reduced amounts of MA (e.g., at 5 wt %) as evidenced by the reduction in conversion ratio even as the conversion ratio plateaus over time. In fact, there is significant reduction in conversion rate when a higher light intensity (70 mW/cm²) is applied to a rubbery photopolymer system with a greater amount of catalyst (4000 ppm of CoBF-iPr) and a smaller ratio of reactive diluent MA (5 wt %). It is speculated that, while the addition of acrylates as reactive diluent makes the Co(III) complex catalyst approximately 25-times less active, the higher intensity of light during the cure process promotes the formation of Co²⁺ and free radical. That is, the higher light intensity drives the process of cleaving the Co—C bond from the secondary radical, especially since a tertiary radical is more stable than a secondary radical. In this way, increased light intensity may be used to influence the catalyst activity in a photopolymer system, even in the presence of acrylates in the formulation.

As used herein, the recitation of “at least one of A, B and C” is intended to mean “either A, B, C or any combination of A, B and C.” The previous description of the disclosed embodiments is provided to enable any person skilled in the art to make or use the present disclosure. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

The terms and expressions employed herein are used as terms and expressions of description and not of limitation, and there is no intention, in the use of such terms and expressions, of excluding any equivalents of the features shown and described or portions thereof. Each of the various elements disclosed herein may be achieved in a variety of manners. This disclosure should be understood to encompass each such variation, be it a variation of an embodiment of any apparatus embodiment, a method or process embodiment, or even merely a variation of any element of these. Particularly, it should be understood that the words for each element may be expressed by equivalent apparatus terms or method terms-even if only the function or result is the same. Such equivalent, broader, or even more generic terms should be considered to be encompassed in the description of each element or action. Such terms can be substituted where desired to make explicit the implicitly broad coverage to which this invention is entitled.

As but one example, it should be understood that all action may be expressed as a means for taking that action or as an element which causes that action. Similarly, each physical element disclosed should be understood to encompass a disclosure of the action which that physical element facilitates. Such changes and alternative terms are to be understood to be explicitly included in the description.

1. A method for tailoring mechanical properties of a photopolymer, the method comprising:
providing an active monomer feedstock;
adding a sulfur-free chain transfer agent (CTA) to the active monomer feedstock to form a mixture; and
curing the mixture under predetermined conditions;
wherein the sulfur-free CTA includes at least one of a Cobalt(II) complex and a Cobalt(III) complex,
wherein mechanical properties include at least one of glass transition temperature, crosslinking density, and conversion rate, and
wherein a concentration of the sulfur-free CTA is less than 30% of the mixture.

2. The method of claim 1, wherein the predetermined conditions include intensity, wavelength, and application time of energy from a light source, a cure temperature, the concentration of the sulfur-free CTA in the mixture, and diffusion of the sulfur-free CTA within the mixture.

3. The method of claim 1, further comprising adding a diluent to the mixture to modify a viscosity of the active monomer feedstock.

4. The method of claim 3, wherein the diluent includes at least one of a reactive diluent and a non-reactive diluent.

5. The method of claim 3, wherein the diluent includes at least one of methyl methacrylate (MMA) and methacrylate (MA).

6. The method of claim 1, wherein adding the sulfur-free CTA includes adding CoBF-iPr as the sulfur-free CTA.
